(19) United States
(12) Patent Application Publication
(10) Pub. No.: US 2013/0129273 A1
(43) Pub. Date: May 23, 2013

(54) POLARIZATION SEPARATION ELEMENT AND OPTICAL INTEGRATED ELEMENT

(71) Applicant: FURUKAWA ELECTRIC CO., LTD., Tokyo (JP)

(72) Inventors: Kazutaka Nara, Tokyo (JP); Takashi Inoue, Tokyo (JP); Hiroshi Kawashima, Tokyo (JP); Noritaka Matsubara, Tokyo (JP)

(73) Assignee: FURUKAWA ELECTRIC CO., LTD., Tokyo (JP)

(21) Appl. No.: 13/746,749

(22) Filed: Jan. 22, 2013

Related U.S. Application Data
(63) Continuation of application No. PCT/JP2012/058588, filed on Mar. 30, 2012.

(30) Foreign Application Priority Data
Mar. 31, 2011 (JP) 2011-080645

(51) Int. Cl. G02B 6/10

(52) U.S. Cl. CPC G02B 6/105
USPC 385/11

(57) ABSTRACT

A polarization separation element of an optical waveguide type formed on a substrate includes: an input-light demultiplexer; an output-light multiplexer; a first arm waveguide and a second arm waveguide that connect the input-light demultiplexer and the output-light multiplexer, each of the first and second arm waveguides including an optical waveguide having birefringence; and at least one heating unit formed above each of the first arm waveguide and the second arm waveguide, wherein a geometric length of the second arm waveguide is larger than a geometric length of the first arm waveguide by equal to or less than a degree corresponding to an amount of increase in an optical path length generated in the first arm waveguide when the at least one heating unit performs heating on the first arm waveguide to impart birefringence to the first arm waveguide.

### CROSS-REFERENCE TO RELATED APPLICATIONS

This application is a continuation of PCT International Application No. PCT/JP2012/058588 filed on Mar. 30, 2012, which claims the benefit of priority from the prior Japanese Patent Application No. 2011-080645 filed on Mar. 31, 2011. The entire contents of these applications are incorporated herein by reference.

### BACKGROUND OF THE INVENTION

1. Field of the Disclosure

The disclosure relates to an optical waveguide type polarization separation element formed on a substrate and an optical integrated element using the polarization separation element.

2. Description of the Related Art

In order to realize an optical waveguide type polarization separation element with a planar lightwave circuit (PLC) formed on a substrate, there is a method in which a Mach-Zehnder interferometer (MZI) is configured of optical waveguides and a difference in birefringence is imparted between two arm waveguides thereof. Birefringence means a difference between refractive index values for TE polarization and TM polarization of an optical waveguide. Arm waveguides originally have birefringence but by imparting a birefringence difference thereon, a polarization separation element is realized.

As methods of imparting a birefringence difference between arm waveguides, various methods are known, such as a method of varying optical waveguide widths among arm waveguides (e.g., see non-patent reference by Y. Hashizume et al., “Integrated polarisation beam splitter using waveguide birefringence dependence on waveguide core width,” Electronics Letters, Vol. 37, No. 25, p. 1517 (2001)) and a so-called thermal trimming method of heating an arm waveguide with a micro heater to impart birefringence thereto (e.g., see a non-patent reference by M. Abe et al., “Optical path length trimming technique using thin film heaters for silica-based waveguide on Si,” Electronics Letters, Vol. 32, No. 19, p. 1818 (1996); and Japanese Patent Nos. 2599488, 3275758, and 3961348). Among these methods, the thermal trimming method is the most practical method. According to the thermal trimming method, not only the birefringence but also a phase between the arm waveguides is adjustable by adjusting a value of a current applied to the micro heater.

Such a polarization separation element is integrated together with a 90-degree hybrid element on the same substrate, for example, and is utilized for a coherent mixer or the like used in a demodulator in a coherent demodulation system such as a dual polarization quadrature phase shift keying (DP-QPSK) system (see a non-patent reference by Sakamaki et al., “One-chip integrated dual polarization optical hybrid using silica-based planar lightwave circuit technology” Proc. of ECOC2009, paper 2.2.4.).

### SUMMARY

### Technical Problem

When one of arm waveguides (referred to as a first arm waveguide) of an MZI interferometer included in a polarization separation element is heated and adjustment to increase birefringence of the first arm waveguide is performed, an effective refractive index of the first arm waveguide is concurrently increased. This causes a large difference between effective optical lengths of the first arm waveguide and the other second arm waveguide, and a free spectral range (FSR) of the MZI interferometer is decreased. As a result, a problem arises in that an operating wavelength bandwidth of the polarization separation element is narrowed.

Accordingly, there is a need to provide a polarization separation element and an optical integrated element having wide operating wavelength bandwidths.

### SUMMARY OF THE INVENTION

According to an embodiment of the present invention, a polarization separation element of an optical waveguide type formed on a substrate includes: an input-light demultiplexer; an output-light multiplexer; a first arm waveguide and a second arm waveguide that connect the input-light demultiplexer and the output-light multiplexer, each of the first and second arm waveguides including an optical waveguide having birefringence; and at least one heating unit formed above each of the first arm waveguide and the second arm waveguide, in which a geometric length of the second arm waveguide is larger than a geometric length of the first arm waveguide by equal to or less than a degree corresponding to an amount of increase in an optical path length generated in the first arm waveguide when the at least one heating unit performs heating on the first arm waveguide to impart birefringence to the first arm waveguide.

According to another embodiment of the present invention, an optical integrated element includes: the polarization separation element; and two optical waveguide type 90-degree hybrid elements that connect to the polarization separation element, in which the polarization separation element and the two optical waveguide type 90 degree hybrid elements are integrated on a same substrate.

The above and other objects, features, advantages and technical and industrial significance of this invention will be better understood by reading the following detailed description of presently preferred embodiment of the invention, when considered in connection with the accompanying drawings.

### BRIEF DESCRIPTION OF THE DRAWINGS

FIG. 1 is a schematic plan view of a polarization separation element according to a first embodiment.

FIG. 2 is a cross-sectional view taken along a line X-X in the polarization separation element illustrated in FIG. 1.

FIG. 3 is a graph illustrating a relation between phase difference Δφ and P₁ when k=0.5.

FIG. 4 is a graph illustrating a relation between the phase difference Δφ and P₂ when k=0.5.

FIG. 5 is a graph illustrating a relation between trimming time for a first arm waveguide and refractive index of the first arm waveguide.

FIG. 6 is a schematic plan view of a polarization separation element according to a second embodiment.

FIG. 7 is a graph illustrating a relation between phase difference Δφ and P₁ when k=0.5.

FIG. 8 is a graph illustrating a relation between the phase difference Δφ and P₂ when k=0.5.

FIG. 9 is a schematic plan view of an optical integrated element according to a third embodiment.

### DETAILED DESCRIPTION OF THE INVENTION

Embodiments of a polarization separation element and an optical integrated element according to the present invention are described in detail below with reference to the accompanying drawings. The embodiments do not limit the present invention. In the drawings, the same or corresponding elements are labeled with the same reference numerals as appropriate. In addition, it is to be noted that the drawings are schematic and relations between thicknesses and widths of each layer, ratios among layers, and the like may differ from those of the actual. Furthermore, portions having relations and ratios of dimensions that differ among the drawings may be included.

### First Embodiment

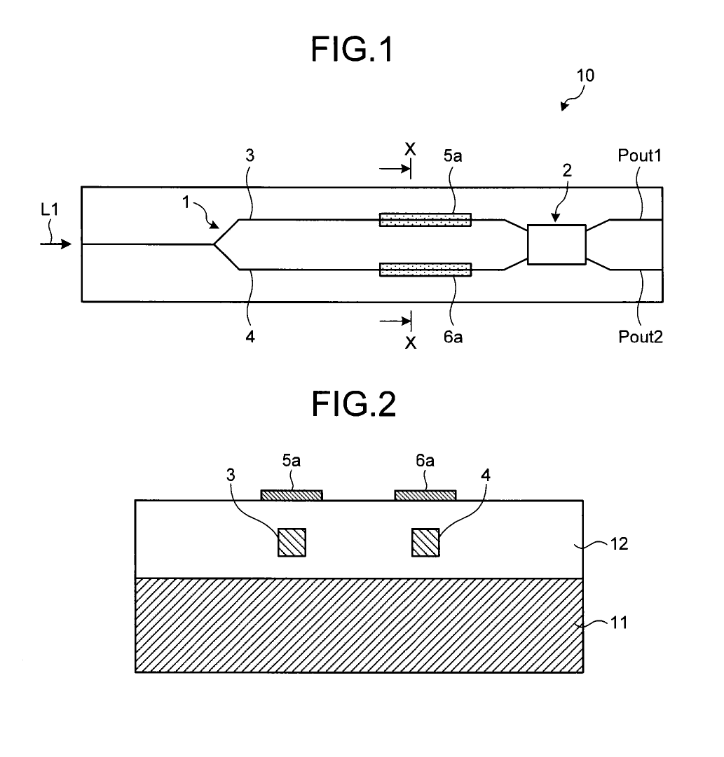

A polarization separation element according to a first embodiment of the present invention is described below. FIG. 1 is a schematic plan view of the polarization separation element according to the first embodiment. As illustrated in FIG. 1, a polarization separation element 10 includes an input-light demultiplexer 1, an output-light multiplexer 2, a first arm waveguide 3 and a second arm waveguide 4 that connect the input-light demultiplexer 1 and the output-light multiplexer 2, a trimming heater 5a, which is a first heating unit formed above the first arm waveguide 3, and a trimming heater 6a, which is a second heating unit formed above the second arm waveguide 4. The polarization separation element 10 is configured of an MZI interferometer.

The input-light demultiplexer 1 is configured of a Y-branch waveguide and branches light L1 input from an input port into two light beams and inputs them respectively to the first arm waveguide 3 and the second arm waveguide 4.

The output-light multiplexer 2 is configured of a directional coupler, which is of an optical waveguide type and a two-input and two-output type, and upon reception of the light beams that have propagated the first arm waveguide 3 and the second arm waveguide 4 respectively, couples these light beams and outputs them from output ports Pout1 and Pout2.

FIG. 2 is a cross-sectional view taken along a line X-X in the polarization separation element 10 illustrated in FIG. 1. As illustrated in FIG. 2, the first arm waveguide 3 and the second arm waveguide 4 are configured by forming, in a cladding layer 12 made of silica-based glass and formed on a substrate 11 such as silicon, core portions having refractive indices higher than that of the cladding layer 12. Similarly, the input-light demultiplexer 1 and the output-light multiplexer 2 are also configured by forming, in the cladding layer 12, core portions.

The trimming heaters 5a and 6a are thin film heaters made of a heater material such as a tantalum (Ta) based material. The trimming heaters 5a and 6a are formed on the cladding layer 12.

A cross-section of the core portion configuring each optical waveguide of the polarization separation element 10 has a size of 6 μm×6 μm, for example. A relative refractive index difference of the core portion to the cladding layer 12 is 0.75%, for example. A distance between the first arm waveguide 3 and the second arm waveguide 4 is 250 μm, for example. Each of the trimming heaters 5a and 6a has a size with a thickness of 0.1 μm and a width of 40 μm, for example. A cross-sectional structure (a size and an effective refractive index) of each of the arm waveguides 3 and 4 is approximately the same throughout its optical waveguide direction.

In the polarization separation element 10, the geometric length of the second arm waveguide 4 is larger than that of the first arm waveguide 3. The details thereof are described later.

Characteristics of the polarization separation element 10 are described below. An optical intensity of the light L1 input to the input-light demultiplexer 1 of the polarization separation element 10 is P₀, an amount of phase delay (phase difference) of light having propagated through the first arm waveguide 3 with respect to light having propagated through the second arm waveguide 4 is Δφ, and a coupling efficiency of the output-light multiplexer 2 is k. Intensities P₁ and P₂ of output light beams obtained from the output ports Pout1 and Pout2 of the output-light multiplexer 2 may be expressed by Equations (11) and (12), respectively.

$$\begin{matrix}{P}_{1} = \frac{{P}_{0}}{2} [ 1 + 2 \sqrt{k ( 1 - k ) sin Δφ} ] & ( 11 ) \\ {P}_{2} = \frac{{P}_{0}}{2} [ 1 - 2 \sqrt{k ( 1 - k ) sin Δφ} ] & ( 12 )\end{matrix}$$

To make the discussion simple, if the coupling efficiency k is assumed to be 0.5, Equations (11) and (12) become Equations (11a) and (12a) below.

$$\begin{matrix}{P}_{1} = \frac{{P}_{0}}{2} ( 1 + sin Δφ ) & ( 11 a ) \\ {P}_{2} = \frac{{P}_{0}}{2} ( 1 - sin Δφ ) & ( 12 a )\end{matrix}$$

Even if k is set to 0.5, generality of the discussion is not lost.

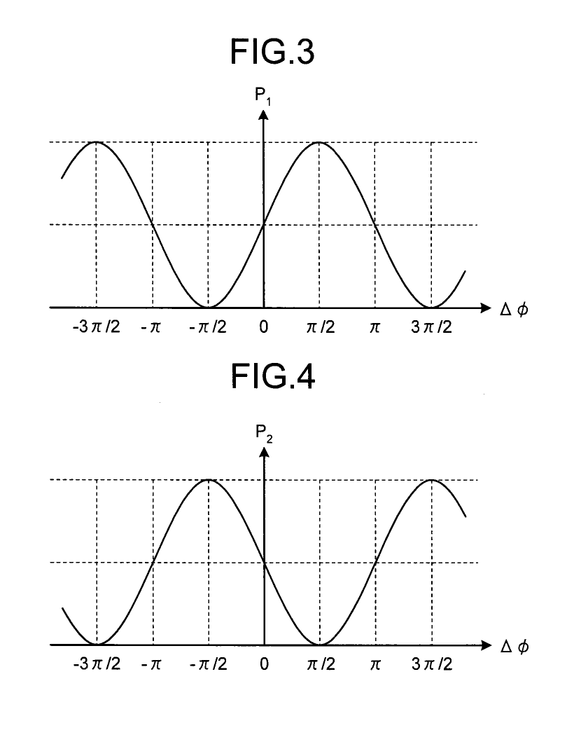

FIG. 3 is a graph illustrating a relation between the phase difference Δφ and P₁ when k=0.5. FIG. 4 is a graph illustrating a relation between the phase difference Δφ and P₂ when k=0.5. From FIGS. 3 and 4, when the conditions of the phase difference Δφ expressed by Equations (13) and (14) below are satisfied, for example, the polarization separation element 10 functions as a polarization separation element that outputs light of a TM polarization component from the output port Pout1 and light of a TE polarization component from the output port Pout2. Here, Δφ_{TM} is the phase difference for TM polarization and Δφ_{TE} is the phase difference for TE polarization.

Δφ_{TM}=π/2 (13)

Δφ_{TE}=−π/2 (14)

Upon setting Δφ for each polarization state, the function as a polarization separation element is not lost even if setting to a value, which is a sum of Δφ satisfying Equation (13) or (14) and an integral multiple of 2π, is done. However, an increase in an absolute value of Δφ is not preferable because an FSR of the MZI interferometer is decreased, resulting in narrowing of an operating wavelength bandwidth of the polarization separation element. Therefore, in the polarization separation element 10 illustrated in FIG. 1, it is preferable if Δφ for each polarization state is set to either of ±π/2 such that Equation (13) or (14) is satisfied, because the operating wavelength bandwidth is able to be widened the most.

When the polarization separation element 10 is manufactured, it is preferable to perform trimming that imparts birefringence to the first arm waveguide 3 by the trimming heater 5a to satisfy Equations (13) and (14). When a length of a portion over which an effect of the trimming acts (i.e., birefringence is imparted) in the first arm waveguide 3 is L₁, an average of effective refractive indices (hereinafter, the effective refractive index is simply referred to as refractive index) in a length direction of that portion is n₁, a portion over which the effect of the trimming acts in the second arm waveguide 4 is L₂, an average of the refractive indices in that portion is n₂, and the wavelength of input light L1 is λ, then the phase difference Δφ is expressed by the following Equation (15).

$$Δφ = \frac{2 π}{λ} ( {n}_{1} {L}_{1} - {n}_{2} {L}_{2} ) \qquad ( 15 )$$

The length L₁, which is the length of the portion over which the effect of the trimming acts in the first arm waveguide 3, is approximately equal to the length of the trimming heater 5a. The length L₂, which is the length of the portion over which the effect of the trimming acts in the second arm waveguide 4, is approximately equal to the length of the trimming heater 6a.

Applying the conditions given by Equations (13) and (14) to Equation (15), the phase differences Δφ for TM and TE polarization components are expressed by Equations (13a) and (14a) below. Here, n_{iTE} and n_{iTM} (i=1, 2) mean values of nᵢ for light of the TE and TM polarization components, respectively.

$$\begin{matrix}{Δφ}_{TE} = \frac{2 π}{λ} ( {n}_{1 TE} {L}_{1} - {n}_{2 TE} {L}_{2} ) = - \frac{π}{2} & ( 13 a ) \\ {Δφ}_{TM} = \frac{2 π}{λ} ( {n}_{1 TM} {L}_{1} - {n}_{2 TM} {L}_{2} ) = - \frac{π}{2} & ( 14 a )\end{matrix}$$

From Equations (13a) and (14a), for birefringence, Bᵢ=n_{iTM}−n_{iTE}, of each optical waveguide of the first arm waveguide 3 and the second arm waveguide 4, and an inter-polarization average, n_{iAve}=(n_{iTM}+n_{iTE})/2, of the refractive indices of the TE and TM polarization components, relational expressions to be satisfied between the first arm waveguide 3 and the second arm waveguide 4, when the polarization separation element 10 functions, are expressed by Equations (16) and (17) below.

$$\begin{matrix}{B}_{1} {L}_{1} - {B}_{2} {L}_{2} = \frac{λ}{2} & ( 16 ) \\ {n}_{1 Ave} {L}_{1} - {n}_{2 Ave} {L}_{2} = 0 & ( 17 )\end{matrix}$$

That is, the polarization separation element 10 is able to have a desired polarization separation function by performing the trimming to satisfy Equations (16) and (17). When L₁=L₂=L in Equations (16) and (17), the trimming to make the birefringence B₁ of the first arm waveguide 3 larger than the birefringence B₂ of the second arm waveguide 4 by λ/(2L) and the averages of the refractive indices of the TE and TM polarization components equal to each other may be performed.

For example, when L₁=L₂=L=4 mm and λ=1.55 μm, ΔB=(B₁−B₂)=λ/(2L)=1.9375×10⁻⁴. Therefore, a current is applied to the trimming heater 5a of the first arm waveguide 3 to perform trimming such that a birefringence value of the first arm waveguide 3 becomes larger than that of the second arm waveguide 4 by ΔB=1.9375×10⁻⁴.

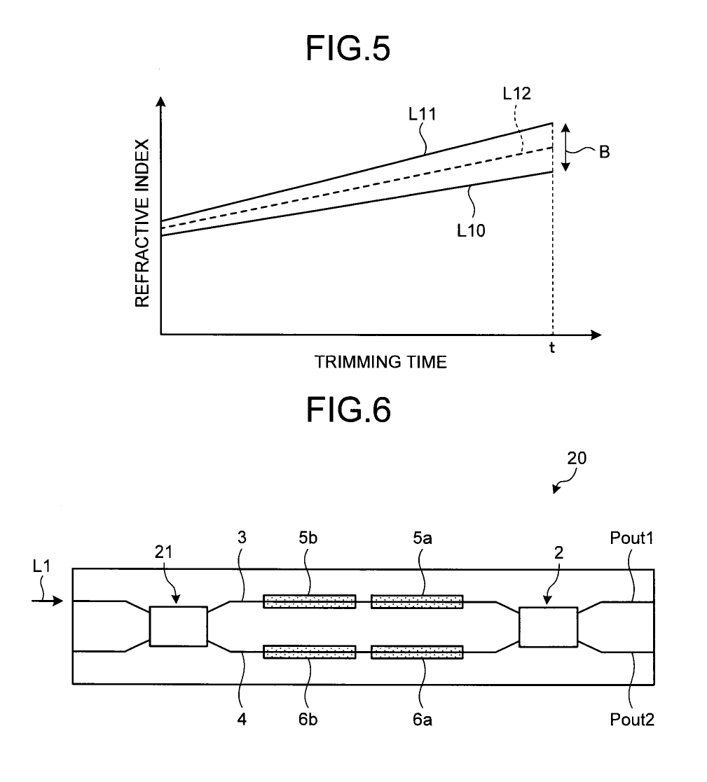

When trimming is performed on an optical waveguide, its birefringence increases as trimming time is increased, and refractive index also increases therewith. For example, FIG. 5 is a graph illustrating a relation between the trimming time of the first arm waveguide 3 and the refractive index of the first arm waveguide 3. In the graph, a line L10 represents a refractive index n_{1TE} for the TE polarization component, a line L11 represents a refractive index n_{1TM} for the TM polarization component, and a line L12 represents the inter-polarization refractive index average n_{iAve}=(n_{iTM}+n_{iTE})/2 for n_{1TE} and n_{1TM}. A birefringence B represents the birefringence B₁=n_{1TM}−n_{1TE} at trimming time t.

As illustrated in FIG. 5, with an increase in the trimming time, the birefringence B₁ increases, and the refractive indices n_{1TM} and n_{1TE}, and the inter-polarization average n_{iAve} also increase therewith. For example, an amount of increase in n_{1Ave} found from actually measured values by the inventors is δn₁=4×10⁻⁴.

When the refractive index of the first arm waveguide 3 increases like this, a large difference may be generated between effective optical path lengths of the first arm waveguide 3 and the second arm waveguide 4. Generation of such a large optical path length difference is not preferable for realizing a polarization separation element having a wide operating wavelength bandwidth because an absolute value of the phase difference Δφ becomes greater.

In order to reduce the absolute value of the phase difference Δφ, trimming to increase the refractive index of the second arm waveguide 4 may be performed. When trimming is performed on the second arm waveguide 4, however, ΔB achieved by the trimming on the first arm waveguide 3 may become smaller. This is not preferable because the polarization separation performance is degraded as a result of this. Or, it is not preferable because the trimming on the first arm waveguide 3 must be performed taking into consideration the decrease in ΔB and designing thereof becomes cumbersome.

In contrast, in the polarization separation element 10 according to the first embodiment, the geometric length of the second arm waveguide 4 is larger than that of the first arm waveguide 3 as described above. Specifically, the geometric length of the second arm waveguide 4 is larger than that of the first arm waveguide 3 by a degree corresponding to an amount of increase in the optical path length of the first arm waveguide 3 generated when the trimming is performed on the first arm waveguide 3. Because the geometric length of the second arm waveguide 4 is preliminarily set to be larger than that of the first arm waveguide 3 by a degree corresponding to the amount of increase in the optical path length of the first arm waveguide 3 like this, a large difference is not generated between the effective optical path lengths of the first arm waveguide 3 and second arm waveguide 4 after the trimming and the phase difference Δφ becomes small. As a result, the polarization separation element 10 is a polarization separation element having a wide operating wavelength bandwidth.

For example, if the inter-polarization averages of the effective refractive indices for the TE and TM polarizations in the first arm waveguide 3 and the second arm waveguide 4 before the trimming are n_{1Ave0} and n_{2Ave0}, respectively, and the amount of increase in the inter-polarization average of the refractive indices when the trimming is performed on the first arm waveguide 3 is δn₁, a difference δL₂ between the geometric lengths of the first arm waveguide 3 and the second arm waveguide 4 is preferably set to satisfy Equation (18) below. When L₁=L₂=L and n_{1Ave0}=n_{2Ave0}, Equation (18) becomes Equation (18a).

$$\begin{matrix}δ {L}_{2} = \frac{{n}_{1 Ave 0} + δ {n}_{1}}{{n}_{2 Ave 0}} {L}_{1} - {L}_{2} & ( 18 ) \\ δ {L}_{2} = \frac{δ {n}_{1}}{{n}_{2 Ave 0}} L & ( 18 a )\end{matrix}$$

For example, δL₂=1.103 μm when n_{2Ave0}=1.45, L=4 mm, and δn₁=4×10⁻⁴. This length is a large value that is longer than the length corresponding to one wavelength of a light wave, which is λ/n_{2Ave0}=1.069 μm, and equal to or larger than 2π in terms of phase difference. The length is equal to or greater than 10 times a typical manufacturing error related to geometric lengths of arm waveguides, which is approximately 0.1 μm. It is preferable for achieving an effect of the present invention that δL₂ is made equal to or greater than three times the typical manufacturing error, which is, for example, equal to or greater than 0.3 μm.

When the above length difference δL₂ is calculated and applied to designing of a geometric length of the second arm waveguide 4, a value of the amount of increase δn₁ in the average of the refractive indices when the trimming is performed on the first arm waveguide 3 is needed. The amount of increase δn₁ may be found by obtaining data from preliminary experiments, deriving theoretically, or the like.

As described above, the polarization separation element 10 according to the first embodiment has a wide operating wavelength bandwidth.

In the first embodiment, the geometric length of the second arm waveguide 4 is larger than that of the first arm waveguide 3 by a degree corresponding to the amount of increase in the optical path length of the first arm waveguide 3 generated when the trimming is performed on the first arm waveguide 3. However, the geometric length of the second arm waveguide 4 may be shorter than this. For example, although Equations (18) and (18a) are equalities, the length difference δL₂ may be smaller than a value that satisfies Equations (18) and (18a). In this case, the trimming is preferably performed on the second arm waveguide 4 because the absolute value of the phase difference Δφ may not be reduced to a sufficiently small value in some cases due to the provision of the length difference δL₂. This is preferable because the amount of trimming may be made smaller than that in a case where the length difference δL₂ is not provided, and thus the deterioration of the polarization separation function is suppressed or complexity of designing is decreased.

An effect of optical path length correction of the second arm waveguide 4 in a stage prior to performing the trimming to increase the birefringence of the first arm waveguide 3 is described below. When n_{1Ave0}=n_{2Ave0}=n₀, L₁=L, and L₂=L+δL₂, the phase difference Δφ of Equation (15) is expressed by Equation (15b).

$$Δφ = - \frac{2 π}{λ} {n}_{0} δ {L}_{2} \qquad ( 15 b )$$

From FIG. 3, it is understood that Δφ=−π/2 and light becomes extinct at the output port Pout1 when δL₂=λ/(4n₀). Extinction of light at any of the output ports is not preferable because a problem is caused in evaluating chip characteristics of the polarization separation element before the trimming. In contrast, when δL₂ is selected to be a value that satisfies Δφ=−mπ (m is an integer equal to greater than zero), a ratio of powers of the output light beams obtained from Pout1 and Pout2 before the trimming becomes 1:1, which is convenient for evaluation of the characteristics. Therefore, δL₂ is preferably set to a value that satisfies Equation (19). It is preferable to set a value of m to an integer equal to or greater than zero and equal to or less than “a maximum integer for which δL₂ does not to exceed a value satisfying Equation (18)”.

$$δ {L}_{2} = \frac{m λ}{2 {n}_{0}} \qquad ( 19 )$$

### Second Embodiment

A polarization separation element according to a second embodiment of the present invention is described below. FIG. 6 is a schematic plan view of the polarization separation element according to the second embodiment. As illustrated in FIG. 6, a polarization separation element 20 is one of which the input-light demultiplexer 1 is replaced with an input-light demultiplexer 21 and added with trimming heaters 5b and 6b in the polarization separation element 10 illustrated in FIG. 1.

The input-light demultiplexer 21 is configured of a directional coupler of an optical waveguide type and a two-input and two-output type, branches light L1 input from one of the input ports into two light beams, and inputs them to the first arm waveguide 3 and the second arm waveguide 4 respectively.

The polarization separation element 20 has different characteristics from those of the polarization separation element 10 because the input-light demultiplexer 21 is configured of the directional coupler. The characteristics of the polarization separation element 20 are described below.

The optical intensity of the light L1 input to the input-light demultiplexer 21 of the polarization separation element 20 is P₀, the amount of phase delay (phase difference) of light having propagated through the first arm waveguide 3 with respect to light having propagated through the second arm waveguide 4 is Δφ, and the coupling efficiency of the input-light demultiplexer 21 and the output-light multiplexer 2 is k. The intensities P₁ and P₂ of the output light beams obtained from the output ports Pout1 and Pout2 of the output-light multiplexer 2, respectively, may be expressed by Equations (31) and (32), respectively.

P₁−P₀[1+2k(k−1)(1+cos Δφ)] (31)

P₂=2k(1−k)P₀(1+cos Δφ) (32)

To make the discussion simple, if the coupling efficiency k is assumed to be 0.5, Equations (31a) and (32a) below are derived from Equations (31) and (32).

$$\begin{matrix}{P}_{1} = \frac{{P}_{0}}{2} ( 1 - cos Δφ ) & ( 31 a ) \\ {P}_{2} = \frac{{P}_{0}}{2} ( 1 + cos Δφ ) & ( 32 a )\end{matrix}$$

Even if k is set to 0.5, generality of the discussion is not lost.

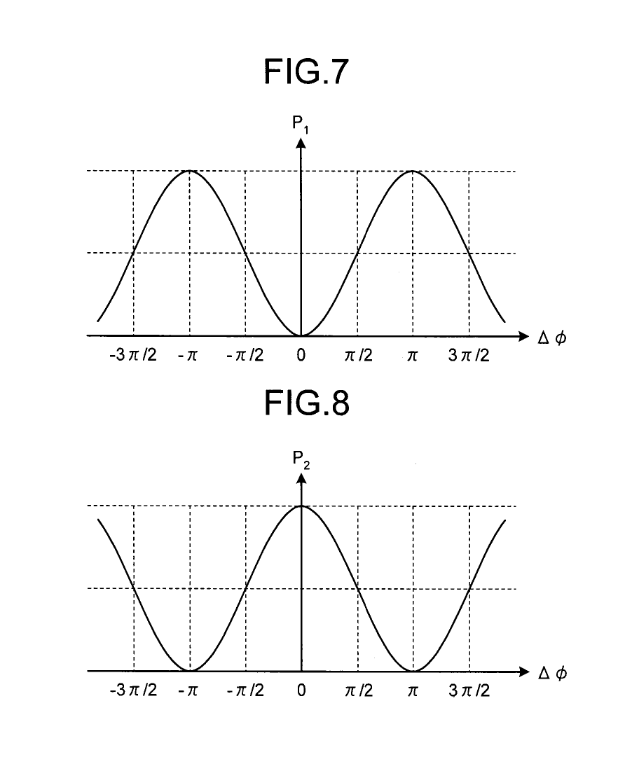

FIG. 7 is a graph illustrating a relation between the phase difference Δφ and P₁ when k=0.5. FIG. 8 is a graph illustrating a relation between the phase difference Δφ and P₂ when k=0.5. From FIGS. 7 and 8, when the conditions of the phase difference Δφ expressed by Equations (33) and (34) below are satisfied, for example, the polarization separation element 20 functions as a polarization separation element that outputs light of a TM polarization component from the output port Pout1 and light of a TE polarization component from the output port Pout2.

Δφ_{TM}=π (33)

Δφ_{TE}=0 (34)

Upon setting the phase difference Δφ for each polarization state, even if setting to a value, which is a sum of Δφ satisfying Equation (33) or (34) and an integral multiple of 2π, is performed, its function as a polarization separation element is not lost. However, as an absolute value of Δφ_{TE} becomes greater than zero, the FSR of the MZI interferometer decreases, resulting in narrowing of the operating wavelength bandwidth of the polarization separation element, which is not preferable. Therefore, Δφ_{TE} is preferably set to zero in the polarization separation element 20 illustrated in FIG. 6 because the operating wavelength bandwidth is able to be widened the most. Further, a similar discussion is possible with respect to Δφ_{TM}. However, for Δφ_{TM}, the maximum operating bandwidth is expected not only for Δφ_{TM}=π but also for Δφ_{TM}=−π and thus either may be employed. A case in which the polarization separation element 20 is manufactured to satisfy Equations (33) and (34) is described below.

When the polarization separation element 20 is manufactured, the trimming that imparts birefringence to the first arm waveguide 3 is preferably performed by the trimming heater 5a for satisfying Equations (33) and (34). The phase difference is expressed by Equation (15) similarly to the first embodiment.

Applying the conditions given by Equations (33) and (34) to Equation (15), the phase differences Δφ for the TM and TE polarization components are expressed by Equations (33a) and (34a) below.

$$\begin{matrix}{Δφ}_{TE} = \frac{2 π}{λ} ( {n}_{1 TE} {L}_{1} - {n}_{2 TE} {L}_{2} ) = 0 & ( 33 a ) \\ {Δφ}_{TM} = \frac{2 π}{λ} ( {n}_{1 TM} {L}_{1} - {n}_{2 TM} {L}_{2} ) = π & ( 34 a )\end{matrix}$$

From Equations (33a) and (34a), with respect to the birefringence Bᵢ of each optical waveguide of the first arm waveguide 3 and the second arm waveguide 4 and the average n_{iAve} of the refractive indices for the TE and TM polarization components, relational expressions to be satisfied between the first arm waveguide 3 and the second arm waveguide 4 when the polarization separation element 20 functions are obtained as Equations (36) and (37) below.

$$\begin{matrix}{B}_{1} {L}_{1} - {B}_{2} {L}_{2} = \frac{λ}{2} & ( 36 ) \\ {n}_{1 Ave} {L}_{1} - {n}_{2 Ave} {L}_{2} = \frac{λ}{4} & ( 37 )\end{matrix}$$

That is, the polarization separation element 20 has a desired polarization separation function by performing the trimming to satisfy Equations (36) and (37). When L₁=L₂=L in Equations (36) and (37), the trimming may be performed such that a value of the birefringence B₁ of the first arm waveguide 3 becomes larger than the birefringence B₂ of the second arm waveguide 4 by λ/(2L) and as for the average of the refractive indices of the TE and TM polarization components, the average n_{1Ave} of the first arm waveguide 3 becomes larger than the average n_{2Ave} of the second arm waveguide 4 by λ/(4L).

For example, when L₁=L₂=L=4 mm and λ=1.55 μm, ΔB=(B₁−B₂)=λ/(2L)=1.9375×10⁻⁴. Therefore, a current is applied to the trimming heater 5a of the first arm waveguide 3 and trimming is performed such that a birefringence value of the first arm waveguide 3 becomes larger than that of the second arm waveguide 4 by ΔB=1.9375×10⁻⁴.

When this is done, as described above, the birefringence B₁ and the average n_{1Ave} both increase as the trimming time increases.

In this regard, also in the polarization separation element 20 according to the second embodiment, the geometric length of the second arm waveguide 4 is made larger than that of the first arm waveguide 3. Specifically, the geometric length of the second arm waveguide 4 is larger than that of the first arm waveguide 3 by a degree corresponding to an amount of increase in the optical path length of the first arm waveguide 3 generated when the trimming is performed on the first arm waveguide 3. As a result, the polarization separation element 20 is a polarization separation element having a wide operating wavelength bandwidth.

For example, the difference δL₂ between the geometric lengths of the second arm waveguide 4 and the first arm waveguide 3 in the polarization separation element 20 is preferably set to satisfy Equation (38) below. When L₁=L₂=L and n_{1Ave0}=n_{2Ave0}, Equation (38) becomes Equation (38a).

$$\begin{matrix}δ {L}_{2} = \frac{{n}_{1 Ave} + δ {n}_{1}}{{n}_{2 Ave 0}} {L}_{1} - {L}_{2} - \frac{λ}{4} & ( 38 ) \\ δ {L}_{2} = \frac{δ {n}_{1}}{{n}_{2 Ave 0}} {L}_{1} - \frac{λ}{4} & ( 38 a )\end{matrix}$$

For example, δL₂=0.716 μm when n_{2Ave0}=1.45, L=4 mm, and δn₁=4×10⁻⁴. This length is large, which is close to the length corresponding to one wavelength of a light wave, which is λ/n_{2Ave0}=1.069 μm, and close to 2π in terms of phase difference. Further, it is long, being approximately 10 times the typical manufacturing error related to the geometric length of the arm waveguide, which is approximately 0.1 μm. For achieving an effect of the present invention, δL₂ is preferably made equal to or greater than three times the typical manufacturing error, e.g., equal to or greater than 0.3 μm.

The amount of increase δn₁ in the inter-polarization average of the refractive indices when the trimming is performed on the first arm waveguide 3 in the polarization separation element 20 may be found by obtaining data from preliminary experiments, theoretically deriving, or the like.

As described above, the polarization separation element 20 according to the second embodiment has a wide operating wavelength bandwidth.

Also in the second embodiment, the geometric length of the second arm waveguide 4 is larger than that of the first arm waveguide 3 by a degree corresponding to an amount of increase in the optical path length of the first arm waveguide 3 generated when the trimming is performed on the first arm waveguide 3. However, the geometric length of the second arm waveguide 4 may be smaller than this. For example, although Equations (38) and (38a) are equalities, the length difference δL₂ may be smaller than the values that satisfy Equations (38) and (38a). This case is also preferable because similarly to the case in the first embodiment, because the trimming amount upon the trimming on the second arm waveguide 4 may be made smaller than that when the length difference δL₂ is not provided, the deterioration of the polarization separation function is suppressed or complexity in designing is decreased.

An effect of optical path length correction of the second arm waveguide 4 in a stage prior to performing the trimming to increase the birefringence of the first arm waveguide 3 is described below. When n_{1Ave0}=n_{2Ave0}=n₀, L₁=L, and L₂=L+δL₂, the phase difference Δφ expressed by Equation (15) is expressed by Equation (15b) as described above.

It is understood from FIGS. 7 and 8 that Δφ=0 and light becomes extinct at the output port Pout1 when δL₂=0, and Δφ=−π and light becomes extinct at the output port Pout2 when δL₂=λ/(2×n₀). Extinction of light at any of the output ports is not preferable because the extinction creates a problem in evaluation of chip characteristics of the polarization separation element before trimming. In contrast, when a value of δL₂ is selected such that Δφ=−(m+0.5)π (m is an integer equal to or greater than zero), a ratio between powers of the output light beams obtained from Pout1 and Pout2 in a stage before trimming becomes 1:1, which is convenient for evaluating characteristics. Therefore, δL₂ is preferably set to a value that satisfies Equation (39). It is preferable that m is set to an integer equal to or greater than zero and equal to or less than “a maximum integer by which δL₂ does not to exceed a value satisfying Equation (38)”.

$$δ {L}_{2} = \frac{( m + 0.5 ) λ}{2 {n}_{0}} \qquad ( 39 )$$

### Third Embodiment

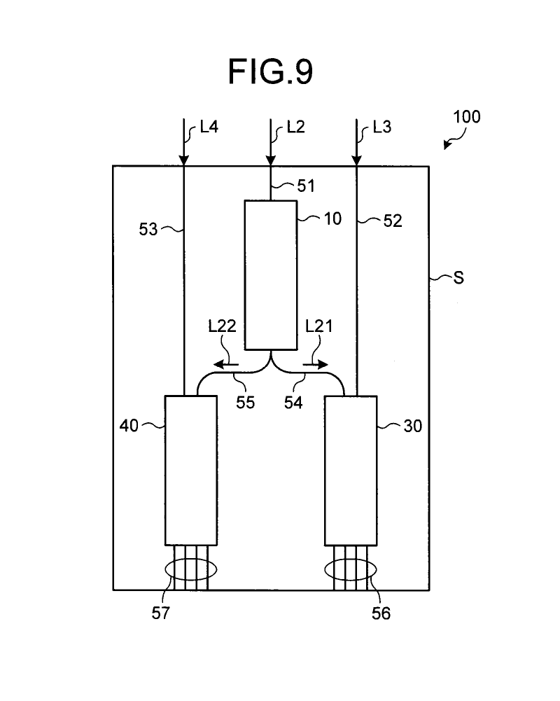

An optical integrated element according to a third embodiment of the present invention is described below. FIG. 9 is a schematic plan view of the optical integrated element according to the third embodiment. As illustrated in FIG. 9, an optical integrated element 100 is formed on a substrate S using a PLC technique and has the polarization separation element 10 according to the first embodiment, and optical waveguide type 90-degree hybrid elements 30 and 40, which are integrated on the substrate S. The optical integrated element 100 includes input optical waveguides 51, 52, and 53 that input light to the polarization separation element 10, and the 90-degree hybrid elements 30 and 40, respectively, connection optical waveguides 54 and 55 that connect the polarization separation element 10 to the 90-degree hybrid elements 30 and 40, respectively, and output optical waveguides 56 and 57 that output the outputs from the 90-degree hybrid elements 30 and 40, respectively, each of the output optical waveguides 56 and 57 being configured of four optical waveguides.

The optical integrated element 100 is configured as a coherent mixer for a DP-QPSK system. An operation of the optical integrated element 100 is described below.

DP-QPSK signal light L2 is input to the input optical waveguide 51 of the optical integrated element 100, and local oscillation light beams L3 and L4 having linear polarizations orthogonal to each other are input to the input optical waveguides 52 and 53, respectively. The polarization separation element 10 polarizes and separates the DP-QPSK signal light L2 into two signal light beams L21 and L22 having linear polarizations orthogonal to each other. Upon receiving the signal light L21 and the local oscillation light L3, the 90-degree hybrid element 30 separates the signal light L21 into signal light of an I channel component and signal light of a Q channel component, and outputs them from the output optical waveguide 56. Likewise, upon receiving the signal light L22 and the local oscillation light L4, the 90-degree hybrid element 40 separates the signal light L22 into signal light of an I channel component and signal light of a Q channel component, and outputs them from the output optical waveguide 57.

The optical integrated element 100 functions as a coherent mixer having a wide operating wavelength bandwidth because it has the polarization separation element 10 according to the first embodiment.

In the embodiments, the directional coupler is used as the input-light demultiplexer or the output-light multiplexer of the two-input and two-output type. However, another optical coupler of the two-input and two-output type may be used as the input-light demultiplexer or the output-light multiplexer. For example, a wavelength-insensitive coupler (WINC) or a multi-mode interferometer (MMI) type optical coupler may be used. Particularly, when the WINCs are used as both the input-light demultiplexer and the output-light multiplexer, phase characteristics of the WINCs are able to be cancelled by arranging, in geometrical point symmetry, the WINCs having the same structure between the input and output sides, as disclosed in K. Jinguji et al., “Two-Port Optical Wavelength Circuits Composed of Cascaded Mach-Zehnder Interferometer with Point-Symmetrical Configurations,” Journal of Lightwave Technology, Vol. 14, p. 2301 (1996). As a result, the polarization separation element that is readily designed and has a wide operating wavelength bandwidth is able to be realized.

In the above embodiments, the trimming method of adjusting the birefringence or the refractive index using one heater for each arm waveguide (the trimming heater 5a or 6a) is described, but like the trimming heaters 5b and 6b illustrated in FIG. 6, two or more heaters may be mounted on each arm waveguide and trimming of adjusting the birefringence or the refractive index of each arm waveguide using the plurality of heaters may be performed.

In the non-patent reference by Y. Hashizume et al., “Integrated polarisation beam splitter using waveguide birefringence dependence on waveguide core width,” Electronics Letters, Vol. 37, No. 25, p. 1517 (2001), birefringence is induced by increasing the width of an optical waveguide. In this case, the FSR may be decreased because a value of the effective refractive index of the optical waveguide is changed. As a result, an operating wavelength bandwidth of the polarization separation element may be narrowed.

In contrast, more preferably, if the cross-sectional structure (the size and the effective refractive index) of the arm waveguide is approximately the same throughout the optical waveguide direction like the polarization separation elements according to the first and the second embodiments, the operating wavelength bandwidth is suppressed from being narrowed and is further widened.

According to the disclosure, a polarization separation element and an optical integrated element having wide operating wavelength bandwidths are able to be realized.

The above-described embodiments do not limit the present invention. Configurations obtained by combining the elements of the embodiments as appropriate are also included in the present invention. For example, the polarization separation element according to the second embodiment may be applied to the optical integrated element according to the third embodiment. Other embodiments, examples, and operation techniques carried out by persons skilled in the art on the basis of the above-described embodiments are all included in the present invention.

What is claimed is:

1. A polarization separation element of an optical waveguide type formed on a substrate, the polarization separation element comprising:
an input-light demultiplexer;
an output-light multiplexer;
a first arm waveguide and a second arm waveguide that connect the input-light demultiplexer and the output-light multiplexer, each of the first and second arm waveguides including an optical waveguide having birefringence; and
at least one heating unit formed above each of the first arm waveguide and the second arm waveguide, wherein
a geometric length of the second arm waveguide is larger than a geometric length of the first arm waveguide by equal to or less than a degree corresponding to an amount of increase in an optical path length generated in the first arm waveguide when the at least one heating unit performs heating on the first arm waveguide to impart birefringence to the first arm waveguide.

2. The polarization separation element according to claim 1, wherein the input-light demultiplexer includes a Y-branch waveguide and the output-light multiplexer is an optical multiplexer of a two-input and two-output type, the optical multiplexer including any one of a directional coupler, a wavelength-insensitive coupler, and a multi-mode interferometer type optical coupler.

3. The polarization separation element according to claim 2, wherein a difference δL₂ between the geometric length of the second arm waveguide and the geometric length of the first arm waveguide is set to satisfy the following Equation (1):
$$δ {L}_{2} \leq \frac{{n}_{1 Ave 0} + δ {n}_{1}}{{n}_{2 Ave 0}} {L}_{1} - {L}_{2} \qquad ( 1 )$$
where n_{1Ave0} is an average of effective refractive indices of TE polarization and TM polarization in the first arm waveguide before the heating is performed, n_{2Ave0} is an average of effective refractive indices of TE polarization and TM polarization in the second arm waveguide before the heating is performed, L₁ is a length of a portion of the first arm waveguide to which the birefringence is imparted by the heating, L₂ is a length of a portion of the second arm waveguide to which the birefringence is imparted by the heating, and δn₁ is an amount of increase in the average of the effective refractive indices when the heating imparting the birefringence is performed on the first arm waveguide.

4. The polarization separation element according to claim 3, wherein the difference δL₂ is set to satisfy the following Equation (2):
δL₂=mλ/(2×n_{2Ave0}) (2)
where λ is a wavelength of light that is input to the input-light demultiplexer and is to be polarized and separated, and m is an integer equal to or greater than zero.

5. The polarization separation element according to claim 1, wherein each of the input-light demultiplexer and the output-light multiplexer is an optical multiplexer of a two-input and two-output type including any one of a directional coupler, a wavelength-insensitive coupler, and a multi-mode interferometer type optical coupler.

6. The polarization separation element according to claim 5, wherein the input-light demultiplexer and the output-light multiplexer are wavelength-insensitive couplers of the same structure and arranged in geometrical point symmetry.

7. The polarization separation element according to claim 5, wherein a difference δL₂ between the geometric length of the second arm waveguide and the geometric length of the first arm waveguide is set to satisfy the following Equation (3):
$$δ {L}_{2} \leq \frac{{n}_{1 Ave 0} + δ {n}_{1}}{{n}_{2 Ave 0}} {L}_{1} - {L}_{2} - \frac{λ}{4} \qquad ( 3 )$$
where n_{1Ave0} is an average of effective refractive indices of TE polarization and TM polarization in the first arm waveguide before the heating is performed, n_{2Ave0} is an average of effective refractive indices of TE polarization and TM polarization in the second arm waveguide before the heating is performed, L₁ is a length of a portion of the first arm waveguide to which the birefringence is imparted by the heating, L₂ is a length of a portion of the second arm waveguide to which the birefringence is imparted by the heating, and δn₁ is an amount of increase in the average of the effective refractive indices when the heating imparting the birefringence is performed on the first arm waveguide.

8. The polarization separation element according to claim 7, wherein the difference δL₂ is set to satisfy the following Equation (4):
δL₂=(m+0.5)×λ/(2×n_{2Ave0}) (4)
where λ is a wavelength of light that is input to the input-light demultiplexer and is to be polarized and separated, and m is an integer equal to or greater than zero.

9. The polarization separation element according to claim 1, wherein a cross-sectional structure of each of the first arm waveguide and the second arm waveguide is approximately the same throughout an optical waveguide direction.

10. An optical integrated element comprising:
the polarization separation element according to claim 1; and
two optical waveguide type 90-degree hybrid elements that connect to the polarization separation element,
wherein the polarization separation element and the two optical waveguide type 90-degree hybrid elements are integrated on a same substrate.
